(19) United States
(12) Patent Application Publication
(10) Pub. No.: US 2015/0360603 A1
(43) Pub. Date: Dec. 17, 2015

(54) Flashing Brake Light System

(71) Applicants: Dean A. Miner, Prosper, TX (US); Alan Humphrey, Austin, TX (US)

(72) Inventors: Dean A. Miner, Prosper, TX (US); Alan Humphrey, Austin, TX (US)

(73) Assignee: Dean Miner, Prosper, TX (US)

(21) Appl. No.: 14/302,797

(22) Filed: Jun. 12, 2014

(51) Int. Cl. B60Q 1/44; B60Q 1/30

(52) U.S. Cl. CPC B60Q 1/44; B60Q 1/302

(57) ABSTRACT

A vehicle having left and right lower rear brake lights and a Center High-Mounted Stop Light (CHMSL) flashes the CHMSL when the brakes are initially applied. The lower brake lights do not automatically flash. After a predetermined duration, the CHMSL remains continuously illuminated until the brakes are removed. In an effort to improve on the design referenced by U.S. Pat. No. 5,345,218, a micro-controller circuit is configured to be activated when brakes are applied. Once activated, internal embedded micro code produce a predetermined number cycles of an oscillating output signal that is responsible for causing the CHMSL to flash. After the numbers of cycles have been completed, the embedded micro code forces the output signal to remain in a state that causes the CHMSL to stay illuminated until the brakes have been removed.

### REFERENCES

### U.S. Patent Documents

| | | |
|---|---|---|
| 5,345,218 | Sep. 6, 1994 | Daniel S. Woods |

### TECHNICAL FIELD OF THE INVENTION

The present improved invention relates generally to the operation of vehicle brake lights. More specifically, the present improved invention relates to operating vehicle brake lights so that the brake lights are automatically flashed when activated.

### BACKGROUND OF THE INVENTION

Brake lights represent one of the many important safety features included on a vehicle. Brake lights indicate when a vehicle's brakes are being applied to signal the driver of the following vehicle of the need to slow down to avoid a rear-end collision. However, in spite of the use of brake lights, the incidence of rear-end collisions remain high. To some degree, the high incidence of rear-end collisions is due to a tendency to follow too closely in traffic. But, the high number of collisions is also due to inattention by the following driver.

Accordingly, brake light systems are designed to grab a following driver's attention. To this end, brake lights tend to exhibit the color red and to be relatively bright when compared to other lights located at the rear of the vehicle. In recent years, the size of these lights has increased, and a center high-mounted stop light (CHMSL), also called the upper or third brake light, has been added to the rear of the vehicle for improved visibility from behind and an improved attention-getting effect. While such enhancements are widely believed to have improved safety, rear-end collisions still occur far too often. In recent years over 2.5 million rear-end collisions a year have occurred, causing more than 2,149 deaths in one year.

Alternative brake light operating systems that possess still greater attention-grabbing characteristics are known. From the NHSTA “an extra second of warning time could prevent 90% of all rear collisions, averting 2.25 million rear end crashes”. Such systems often cause brake lights to flash. However, such alternative brake light operating systems suffer from numerous drawbacks and have not gained public acceptance.

For example, many flashing brake light systems cause brake lights to flash excessively. As a result, the flashing lights become a distraction. After being exposed to such excessive flashing for some time, drivers become immune to the attention grabbing effect of a flashing light and its benefits are lost.

In addition, many flashing brake light systems, whether the flash excessively or not, possess other features that compromise rather than improve safety. For example, many of such systems incorporate notoriously unreliable devices, such as relays and flashers having physical contacts, motors, cams, levers, and other mechanical devices. Such devices often have failure modes that prevent the brake lights from working at all. Consequently, vehicles having such conventional flashing brake light systems can be expected to experience a total failure of brake lights at least once during the useful life of the vehicle. While some incremental safety improvement may be achieved, the improvement is countered by an extremely dangerous total brake light failure.

Furthermore, conventional flashing brake light systems tend to be complex devices. Complex devices are highly disadvantageous for several reasons. They tend to weigh more, be less reliable, and be more expensive than more simple devices. Often times, they are difficult to adapt to a vehicle and are impractical to install in vehicles having normal, non-flashing brake light systems, except at great expense.

### SUMMARY OF THE INVENTION

Accordingly, it is an advantage of the present invention that an improved flashing brake light system is provided.

Another advantage of the present invention is that brake lights are flashed in a subtle manner to retain a high attention-grabbing effect and to refrain from significantly decreasing the attention-grabbing effects of non-flashing brake light systems.

Another advantage of the present invention is that an inexpensive system is provided that is easily installed in existing vehicles having non-flashing brake light systems.

The above and other advantages of the present invention are carried out in one form by an apparatus for indicating the braking status of a vehicle upon the activation of an input signal. The apparatus consists of three major components. The first component is a semiconductor voltage regulator circuit that provides the appropriate voltage to the micro controller upon activation of the input signal. The second component is an 8-bit Flash Micro controller that utilizes embedded micro code to determine how many times to toggle (cycle) the controller output. This output controls the On & OFF states of a high side digital switch, which is third main component of the apparatus.

In Short, upon activation of the brakes (the input signal), the voltage regulator powers up the micro controller which in turn toggles its output to turn the digital switch On & Off for a predetermined number of cycles before holding the switch in the ON state until the activation of the brakes has been removed.

### BRIEF DESCRIPTION OF THE DRAWINGS

A more complete understanding of the present invention may be derived by referring to the detailed description and claims when considered in connection with the FIGURES, wherein like reference numbers refer to similar items throughout the FIGURES, and:

FIG. 1 shows a rear view of a vehicle having a flashing brake light system constructed in accordance with the present invention;

FIG. 2 shows a timing diagram which describes the operation of the present invention;

FIG. 3 shows a schematic block diagram of components used in accordance with the present invention.

### DETAILED DESCRIPTION OF THE PREFERRED EMBODIMENT

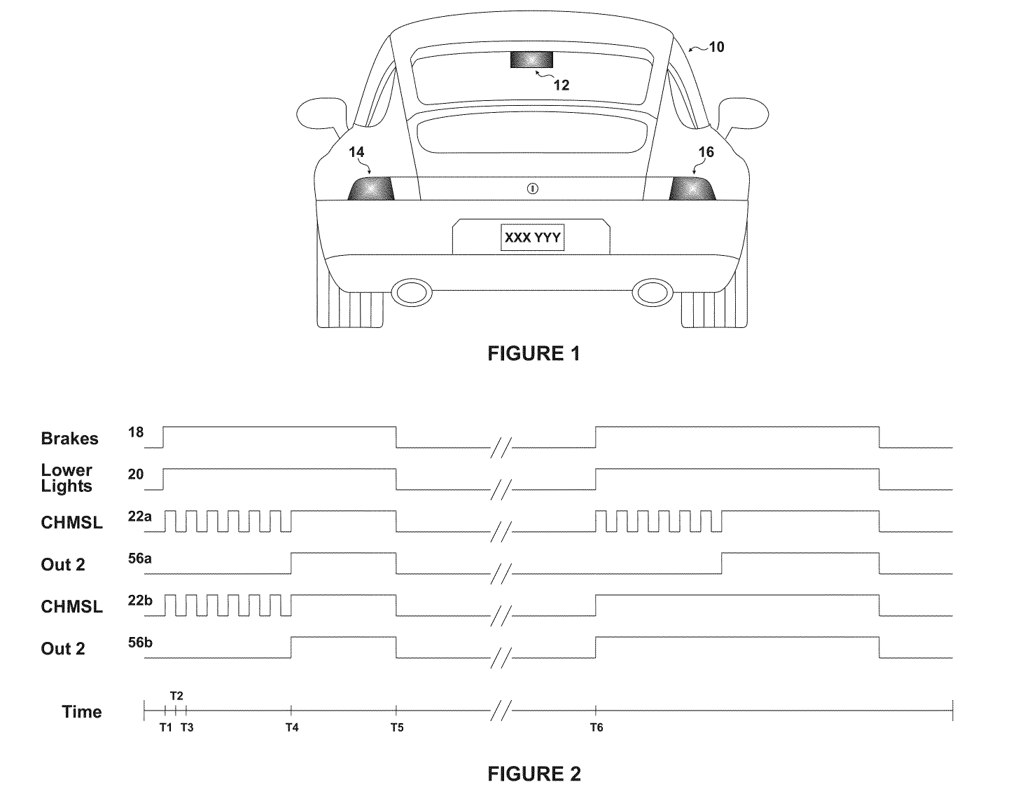

FIG. 1 shows a rear view of a vehicle 10 configured in accordance with the present invention. In particular, vehicle 10 includes a Center High-Mounted Stop Light (CHMSL) 12 along with left and right lower brake lights 14 and 16, respectively. Lights 12-16 serve as indicators that announce when vehicle brakes are being applied. CHMSL 12 is located above lower lights 14-16. In addition, CHMSL 12 is positioned in the center of vehicle 10 while lower brake lights 14-16 are positioned at left and right sides, respectively, of vehicle 10. Lower lights 14-16 may also be associated physically and/or electrically in a conventional manner with turn indicators and with other filaments that serve as running lights.

FIG. 2 shows a timing diagram that describes the operation of lights 12-16. In particular, trace 18 describes an exemplary sequence associated with the application of brakes within vehicle 10. As shown in trace 18, vehicle brakes are applied at a time T₁ and remain applied until removed at a time T₅. Of course, those skilled in the art will appreciate that the driver of vehicle 10 in response to driving conditions controls the application and removal of brakes. Thus, the sequence shown in trace 18 depicts only one of numerous possible braking scenarios. In addition, trace 18 indicates the application and removal of brakes from the driver's perspective. Those skilled in the art will appreciate that the actual application of braking forces to vehicle 10 may be pulsed or otherwise varied in accordance with automatic braking systems while brakes are applied as indicated in trace 18.

As shown in trace 20, lower brake lights 14-16 are continuously activated in accordance with the application of vehicle brakes. Specifically, both of the lower lights 14-16 are activated at time T₁ and remain continuously activated until time T₈. At time T₈ lights 14-16 are deactivated. Thus, whenever vehicle brakes are applied, lower lights 14-16 are activated. Whenever vehicle brakes are not applied, lower lights 14-16 are not activated turn indicators notwithstanding.

Traces 22 illustrate the operation of CHMSL 12. CHMSL 12 operates in a different manner than lower lights 14-16. Whenever vehicle brakes are not applied, CHMSL 12 is deactivated in an identical manner to the lower brake lights 14-16. However, when vehicle brakes are initially applied, as shown at time T₁, CHMSL 12 begins operation in a flashing mode. In particular, CHMSL 12 is activated from time T₁ to a time T₂, deactivated from time T₂ to a time T₃, and so on for a predetermined duration, which trace 22 (a or b) indicates as expiring at a time T₄. In the preferred embodiment of the present invention, this predetermined duration is in the range of 1.5-4 seconds, and more preferably in the range of 2-3 seconds. The rate of flashing is preferably in the range of three to four flashes per second. After time T₆, CHMSL 12 remains continuously activated until vehicle brakes are removed at time T₅.

The duration of the flashing mode of operation (between times T₁ and T₄) accomplishes two goals. First, this duration is preferably relatively short when compared to an average application of brakes. By keeping this duration to less than four seconds, the quantity flashing rear lights experienced by drivers in traffic is held to a low level and excessive flashing is avoided. Consequently, drivers tend not to become immune to attention-grabbing effect of a flashing light, and no significant reduction occurs in the attention-grabbing effect of non-flashing brake lights used by other vehicles. In accordance with a second goal, this duration is preferably long enough so that a significant attention-grabbing effect will result than is achieved from non-flashing light. Hence, improved safety and a reduced likelihood of rear-end collisions may be expected from operating CHMSL 12 in its flashing mode.

The rate of flashing is established so that a distinctive flashing signature results. Typical vehicle flashers cause turn signals and emergency lights to flash at a rate of around 0.75-3.0 times per second, with most flashing at a rate of around 1-2 times per second. Preferable, CHMSL 12 flashes at a rate faster than most turn signals and emergency lights to give a distinctive appearance and a heightened attention-grabbing effect. A heightened attention-grabbing effect results because the faster flashing rate achieves more flashes within the duration of the flashing mode of operation.

While CHMSL 12 operates in its flashing mode, lower lights 14-16 are continuously activated. This feature of the present invention achieves two goals. First, it allows the flashing light operation of the present invention to have a more subtle effect than would result if all of lights 12-14 were flashing. The flashing of CHMSL 12 is balanced by the constancy of lower lights 14-16. Thus, the flashing of CHMSL 12 enhances attention-grabbing effect, but the overall effect when combined with lower lights 14-16 avoids excessive flashing and excessive distraction of others.

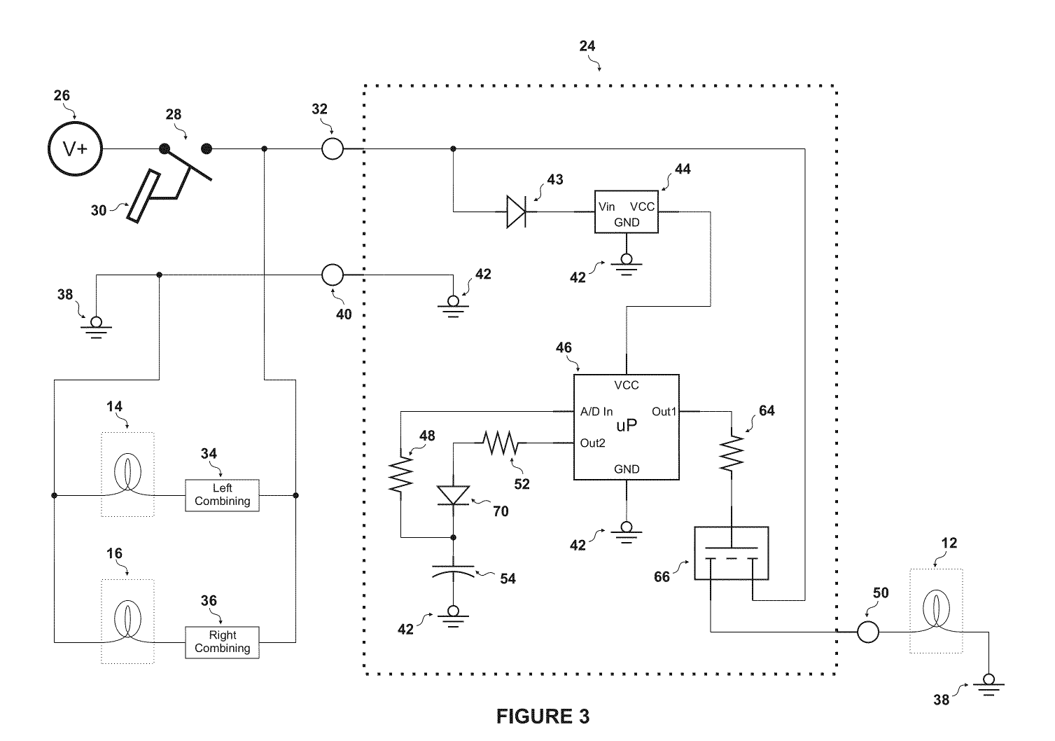

The second goal achieved by operating CHMSL 12 in a flashing mode while constantly activating lower lights 14-16 concerns failure modes. The present invention employs a circuit, discussed below in connection with FIG. 3, to cause CHMSL 12 to behave as indicated in trace 22a of FIG. 2. No circuit beyond those employed in normal, non-flashing brake light systems is used in connection with lower lights 14-16. Accordingly, a failure in the flashing circuit, which is highly unlikely, will not affect operation of lower lights 14-16. As a result, a total brake light failure is virtually impossible from operating the flashing circuit, and failure modes of the present invention do not negatively impact safety in a significant way.

Of course, those skilled in the art will appreciate that brakes may be applied many times in a short period of time in situations of heavy traffic. On these occasions, the present invention employs a portion of the circuit that causes the CHMSL 12 to behave as indicated in trace 22b of FIG. 2 when the length of time between T₅ and T₆ is less than a predetermined duration. In the preferred embodiment of the present invention, this predetermined duration is preferably in the range of 7-9 seconds. In this situation, trace 22b of FIG. 2 indicates that subsequent application of the brakes causes the CHMSL 12 to activate in the same manner as lower lights 14-16.

The elimination of the flashing mode period between successive applications of brakes is desirable because it prevents a driver in heavy traffic situations from continuously flashing CHMSL 12. The prevention of continuous flashing is desirable because it reduces the likelihood of excessive flashing. In the preferred embodiment of the present invention, the flashing mode period is eliminated if the time between T₅ and T₆ is less than 7-9 seconds. In other words, if the brakes are applied within 7-9 seconds of their removal, the flashing mode period is eliminated and CHMSL 12 activates and remains solid in the same manner as lower lights 14-16.

FIG. 3 shows a schematic block diagram of a circuit 24 that causes CHMSL 12 to operate as indicated in trace 22 (a or b) of FIG. 2. Circuit 24 is preferably inserted in series with conductors that drive CHMSL 12 in accordance with a normal non-flashing brake light system.

As is conventional, in vehicle 10 (see FIG. 1) a voltage source 26 applies a supply voltage to the first node of a brake switch 28. Brake switch 28 is operated by brake pedal 30 of vehicle 10. A second node of switch 28 couples to a supply node 32 of circuit 24 and to first nodes of left and right combining circuits 34 and 36, respectively. Combining circuits 34 and 36 combine the brake signal with turn signal circuits (not shown) in some vehicles so that the left and right lower lights 14-16 can indicate both turning and braking for vehicle 10. Second nodes of circuits 34 and 36 couple to the first nodes of left and right lower rear lights 14 and 16, respectively. A ground terminal 38, which is adapted to receive a common potential, couples to a ground node 40 of circuit 24 and to second nodes of lights 14-16.

With reference to circuit 24, ground node 40 couples to a ground terminal 42 of circuit 24. Supply node 32 couples to the Vᵢₙ power terminal of a voltage regulator 44 through diode 43, and to the V_{cc} power source terminal of High Side driver 66. The ground terminals of voltage regulator 44 and High Side driver 66 couple to ground terminal 42. The V_{cc} output of voltage regulator 44 connects to the V_{cc} power terminal of 8-bit Flash Micro controller 46. Accordingly, devices 44 and 46 are energized when brakes are applied through the operation of brake pedal 30 and are de-energized when brakes are removed. Diode 43 prevents failure of devices 44 and 46 when circuit 24 is installed incorrectly by reversing the connections to terminals 32 and 40 causing a reverse voltage situation.

One output (Out1) of the 8-bit Flash Micro controller 46 connects to the digital input terminal of the High Side driver 66 through input protection resistor 64 to control the activation of the High Side driver 66. The output terminal of the High Side driver 66 couples to the output supply node 50 of circuit 24.

Another output (Out2) of the 8-bit Flash Micro controller 46 connects to the anode terminal of diode 70 through resistor 52. The cathode terminal of diode 70 then connects to both the positive node of capacitor 54 and one node of resistor 48. The negative node of capacitor 54 then couples to the ground terminal 42 of circuit 24. The other node of resistor 48 couples to an input (In) of the 8-bit Flash Micro controller 46.

Output supply node 50 of circuit 24 couples to a first node of CHMSL 12. Accordingly, circuit 24 includes an input node and output node that is designed to couple in series with the signal that drives a conventional non-flashing CHMSL 12.

The connection of supply node 32 and diode 43 cause regulator 44 to be energized to produce a digital voltage (V_{cc}) that provides power to Micro Controller 46. In other words, when regulator 44 is energized through application of brakes, regulator 44 provides power to Micro Controller 46.

When power is applied to Micro Controller 46, it activates and begins to run its predetermined micro code otherwise known as the internal program. The operation of this internal program is what determines the functionality of Out 1 and Out 2 of Micro Controller 46.

In the preferred embodiment of the present invention, the internal program first reads A/D In (analog input) to determine the voltage level of the positive node of capacitor 54. If it is below a predetermined value, Micro Controller 46 begins to oscillate Out 1 for a predetermined number of cycles, which causes CHMSL 12 to flash. This is indicated by trace 22a in FIG. 2. If the voltage level read by Micro Controller 46 is NOT below the predetermined value, Micro Controller 46 activates Out 1 and keeps it constant until the power has been removed indicating that the application of the brakes have also been removed. This is indicated by trace 22b in FIG. 2 from time T₆ on.

The frequency and pulse width of the oscillating Out 1 as well as its duration is controlled through the internal program of Micro Controller 46. In the preferred embodiment of the present invention, the duration of the oscillation is in the range of 1.5 to 4 seconds and more preferably in the range of 2 to 3 seconds. The duration of the oscillation is depicted in trace 22a of FIG. 2 between times T₁ and T₄.

With the brakes still being applied through the duration of the predetermined number of oscillating cycles (T₄), Micro Controller 46 stops oscillating Out 1 and keeps it active causing CHMSL 12 to stop flashing and remain solid. This is indicated by trace 22a. Following the completion of the oscillating cycle on Out 1, time T₄, Micro Controller 46 activates Out 2.

Upon activation of Out 2, the current through resistor 52 and diode 70 charges up capacitor 54 causing the voltage level on the positive node of capacitor 70 to increase. This voltage is fed back into the analog input of micro controller 46 through resistor 48 and is used to determine whether or not to initiate the oscillating cycle of Out 2 when 46 becomes active.

When the application of the brakes has been removed and Micro Controller 44 de-activates, capacitor 54 begins discharging slowly through resistor 48 and the analog input of Micro Controller 46. The rate at which capacitor 54 discharges is predetermined by the values of capacitor 54 and resistor 48. Based on the discharge rate of capacitor 54 and the predetermined voltage level threshold seen on the analog input of Micro Controller 46, a minimum time between the removal of the application of the brakes and the subsequent application of the brakes can be used to reduce excessive flashing of CHMSL 12. In the preferred embodiment of the present invention, the predetermined minimum duration is in the range of 7 to 9 seconds.

The prevention of a re-initialized flashing mode upon the quick reapplication of brakes is advantageous because it prevents excessive flashing in situations where brakes are being pumped, as occasionally occurs when vehicles are stopped in traffic.

The reliability of circuit 24 is extremely high. The high reliability results from its simplicity and the use of semiconductor parts rather than mechanical devices. The only active component of circuit 24 that conducts large current is switch 66. However, in the unlikely event that switch 66 fails, its most common failure mode is a short between the source and drain. Consequently, in all likelihood, should a failure occur in connection with circuit 24, the failure will cause light 12 to operate as a conventional non-flashing brake light. The simplicity of circuit 24 also allows it to be manufactured and sold inexpensively. It can be easily installed in vehicles having non-flashing brake lights because its simplicity allows it to occupy an extremely small space and because it requires only the signals that a non-flashing brake light system provides to a CHMSL.

In summary, the present invention provides an improved flashing brake light system. A vehicle's brake lights are flashed in a subtle manner. In particular, only the upper brake light is flashed. It is flashed only for a short period of time, after which it is constantly activated. The lower brake lights do not flash, and if brakes are quickly reapplied after being removed, no automatic flashing occurs. The flashing of brake lights produces an improved attention-grabbing effect. The subtle manner in which the present invention flashes brake lights reduces drivers' immunity to the flashing effect and drivers' immunity to non-flashing brake light systems. The present invention employs a circuit that is highly reliable due to its reliance upon semiconductor components rather than mechanical devices. Moreover, the present invention is configured so that in the unlikely event that a failure occurs, the failure will not produce a dangerous condition since, at a minimum, lower brake lights remain operational, and most probably even the CHMSL remains operational in a non-flashing mode. Further, the present invention relies upon an inexpensive circuit that is easily installed in existing vehicles having non-flashing brake light systems.

The present invention has been described above with reference to a preferred embodiment. However, those skilled in the art will recognize that changes and modifications may be made in this preferred embodiment without departing from the scope of the present invention. For example, those skilled in the art may adapt components other than those mentioned herein to achieve the functions discussed herein. These and other changes and modifications that are obvious to those skilled in the art are intended to be included within the scope of the present invention.

What is claimed is:

1. In a vehicle having an upper light and lower lights viewable from behind said vehicle, said upper and lower lights serving as indicators for braking, a method of operating said upper and lower lights comprising the steps of:
a) continuously activating said lower lights upon application of brakes;
b) initiating a flashing mode of operating said upper light upon the activation of said vehicle brakes;
c) waiting a predetermined duration; and
d) continuously activating said upper light after said predetermined duration when said vehicle brakes remain applied;
e) deactivating said upper and lower lights upon removal of said brakes;
f) continuously activating said upper and lower lights upon re-application of said brakes if the previous deactivation period was less than a predetermined delay period;
g) re-initiating said flashing mode of operating said upper light upon the re-application of said brakes after said delay period.

2. An apparatus for indicating the braking status of a vehicle upon the activation of an input signal, said apparatus comprising:
a) a signal terminal adapted to receive said input signal;
b) a semiconductor power regulator having a power terminal adapted to be energized by said input signal to generate a digital voltage;
c) a semiconductor Micro Controller adapted to be energized by the digital voltage to produce an oscillation output signal alternatively exhibiting activated and inactivated states upon said activation of said input signal;
d) a semiconductor Micro Controller adapted to be energized by the digital voltage to produce a secondary output that activates on completion of output one's predetermine number of oscillation cycles;
e) a capacitor that becomes charged through a diode and resistor coupled to the said secondary output of said Micro Controller;
f) a feedback resistor that is coupled to said capacitor and connected to an analog input of said Micro Controller for the purpose of determining the delay period;
g) a semiconductor switch that has the input coupled to the said oscillating output of said Micro Controller through a resistor and the output is coupled to the output terminal of the apparatus;
h) an output terminal that has the purpose of connecting to the said upper light.

3. An apparatus for indicating the braking status of a vehicle as claimed in claim 2 wherein said oscillating output of said Micro Controller is configured so that said output exhibits it activated state at least two times a second.

4. An apparatus as claimed in claim 2 wherein said Micro Controller is configured so that when said reactivation of said input signal occurs more than the said delay time of approximately 8 seconds following a previous inactivation, the said output of the said Micro Controller oscillates for approximately 3 seconds and then remains activated causing the said switch to oscillate causing said upper brake light to flash and then remain on.

5. An apparatus as claimed in claim 2 wherein said Micro Controller is configured so that when said reactivation of said input signal occurs less than approximately 8 seconds following a previous inactivation, the said output of the said Micro Controller stays activated and does not oscillate causing said switch to remain activated causing said upper brake light to turn on without flashing.
